(19) United States
(12) Patent Application Publication
(10) Pub. No.: US 2021/0194226 A1
(43) Pub. Date: Jun. 24, 2021

(54) SYSTEM AND METHOD FOR REMOVING A PROTECTIVE SHIELD FROM AN ELECTRICAL CABLE

(71) Applicant: Frisimos, Ltd., Ra'anana (IL)

(72) Inventors: Hanan Ben-Ron, Givataim (IL); Tal Pechter, Ramat Hasharon (IL)

(73) Assignee: Frisimos, Ltd., Ra'anana (IL)

(21) Appl. No.: 16/723,401

(22) Filed: Dec. 20, 2019

(51) Int. Cl. H02G 1/12; B23K 26/362

(52) U.S. Cl. CPC H02G 1/128; B23K 26/362; H02G 1/1297

(57) ABSTRACT

A system and method for removing a protective shield from an electrical cable using an ablation process is disclosed. The circumference of the protective shield may not be perfectly circular. To compensate, a measurement, such as a distance measurement to a point on a surface of the electrical cable, is performed. Based on the distance measurement, the system performs a compensation operation, such as moving the lens in the laser system in order to compensate. Thereby, the focus of the laser radiation may be placed consistently at a predetermined position relative to the surface of the protective shield, thereby sufficiently ablating the protective shield without harming interior layers of the electrical cable. Further, the protective shield may be wrapped so that there is an overlap. To account for this, the protective shield on both sides of the ablated groove is held and twisted in order to shear along the groove.

### TECHNICAL FIELD

The present disclosure generally relates to the electrical cable and connector industry, and in particular to a system and method for removing a protective shield, such as a foil shield (e.g., metal foil shield, Mylar shield, etc.) or a mesh (e.g., a metal wire mesh) from electrical wires and/or cables.

### BACKGROUND

Different electrical and electronic equipment and their devices communicate between them through physical connectors and cables. Each device and/or apparatus may have specific connectivity requirements. Connectivity requirements could relate to physical connectivity between devices and to the communication protocol. Physical connectivity requirements could include a range of amplitude of current and/or voltage, Electromagnetic Interference (EMI) protection and others. A cable is most frequently used to connect between different electric and electronic devices.

The electrical cable is usually one or more wires running side by side. The wires can be bonded, twisted, or braided together to form a single assembly. Every current-carrying conductor, including a cable, radiates an electromagnetic field. Likewise, any conductor or cable will pick up electromagnetic energy from any existing around electromagnetic field. This causes losses of transmitted energy and adversely affects electronic equipment or devices of the same equipment, since the noise picked-up is masking the desired signal being carried by the electrical cable.

There are particular cable designs that minimize EMI pickup and transmission. The main design techniques include electromagnetic cable shielding, coaxial cable geometry, and twisted-pair cable geometry. Shielding makes use of the electrical principle of the Faraday cage. The electrical cable is encased for its entire length in a metal foil or a metal wire mesh (shield). The metal could be such as aluminum or copper.

Coaxial cable design reduces electromagnetic transmission and pickup. In this design the current conductors are surrounded a tubular current conducting metal shield which could be a metal foil or a mesh. The foil or mesh shield has a circular cross section with the electric current conductors located at its center. This causes the voltages induced by a magnetic field between the shield and the conductors to consist of two nearly equal magnitudes which cancel each other. To reduce or prevent electromagnetic interference, other types of cables could also include an electromagnetic shield.

Cable assembly is a process that includes coupling of cut to measure individual wires or pair of wires and a metal foil shield into an electrical cable. Connectors terminate one or both ends of the electrical cable. Individual wires are stripped from the isolation and soldered to connector pins. If the electrical cable contains a metal foil shield, the shield has to be at least partially removed to allow unobstructed access to the individual wires and pins.

At present at least the metal shield removal is performed manually with the help of a knife or a cutter that cut the shield. The cut segment of the metal shield is manually removed or separated from the remaining part of the electrical cable. In some occasions the current conducting wires are damaged by the cutting tools. Such manual operation is slow, inaccurate, prone to error and costly.

### BRIEF DESCRIPTION OF THE DRAWINGS

The accompanying drawings, which are incorporated in and constitute a part of this specification, illustrate various aspects of the invention and together with the description, serve to explain its principles. Wherever convenient, the same reference numbers will be used throughout the drawings to refer to the same or like elements.

FIG. 1A illustrates an electrical cable cross section according to a first example;

FIG. 1B illustrates an electrical cable cross section according to a second example;

FIG. 1C illustrates a perspective view of an electrical cable after the protective shield has been removed from a part of the electrical cable;

FIG. 2 is a schematic illustration of a simplified block diagram of a metal foil removal system according to an example;

FIG. 3A is a schematic illustration of an example of a metal foil removal system;

FIG. 3B is a detail of FIG. 3A;

FIG. 4 is a flowchart illustrating the process of with relevant processes of metal foil shield removal according to an example;

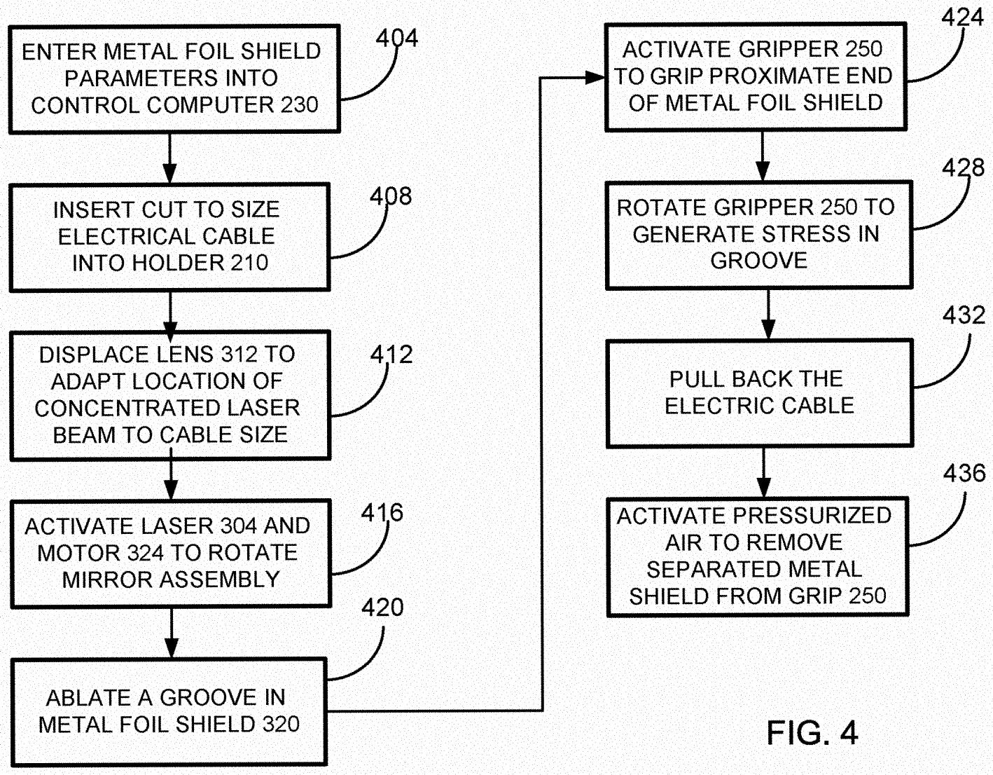

FIG. 5 is a schematic illustration of sensing at least one aspect of the protective shield (such as distance of a sensor to the surface of the protective shield) and modifying at least one aspect of operation to compensate for the sensed aspect (such as moving the focal point of the laser system relative to the electrical cable);

FIG. 6A is a first schematic illustration of moving the lens relative to the electrical cable in order to compensate for variations at a first point of the surface of the electrical cable;

FIG. 6B is a second schematic illustration of moving the lens relative to the electrical cable in order to compensate for variations at a second point of the surface of the electrical cable; and

FIG. 7 is a flowchart illustrating a process of compensating for deviations in the surface of the protective shield according to an example.

FIG. 8A is a cross sectional view of the protective shield prior to laser ablating, including illustrating an overlapping region of the protective shield layer.

FIG. 8B is a cross sectional view of the protective shield, including illustrating both pre and post laser ablating.

FIG. 8C is an expanded view of the protective shield after laser ablating, including illustrating an overlapping region of the protective shield layer remains after laser ablating.

FIG. 9 is a top view illustrating the holder and the gripper both physically contacting the exposed section of the protective shield in order to perform the twisting movement.

FIG. 10A is a first perspective view of an example of the system for removing the protective shield from the electrical cable.

FIG. 10B is a second perspective view (opposite the perspective shown in FIG. 10A) of the example of the system for removing the protective shield from the electrical cable.

FIG. 10C is a cross-sectional view of the system for removing the protective shield from the electrical cable illustrated in FIGS. 10A-B.

### DETAILED DESCRIPTION

The present document discloses a method and apparatus for removal of a protective shield from an electrical cable. Various types of protective shields are contemplated. In one implementation, a metal protective shield (such as an aluminum mesh shield or a metal foil shield) is used. In another implementation, a non-metal protective shield (such as a Mylar (also known as biaxially-oriented polyethylene terephthalate) shield or other type of polyester-based substance), fabric (or other cloth for covering electrical wire)) is used. In still another implementation, a combination of metal and non-metal materials may be used for the protective shield (e.g., an aluminum mesh shield coated with a cellophane or other transparent sheet).

The method is at least in part free of the drawbacks of manual metal foil shield removal. In one implementation, the apparatus is removing the protective shield, such as at least a part of the mesh shield or at least a part of the metal foil shield, using ablation process, shear stress generation and video camera feedback. In one implementation, ablation is a process of removing material from a solid where the material is converted to another aggregate state without any interim aggregate state. For example, metal is converted to plasma or gas without being converted into a liquid state. Ablation supports selective material removal and depth of the groove generated by the ablation process. In one implementation, the process is extremely short and no heat is transferred to underlying wire isolation layers.

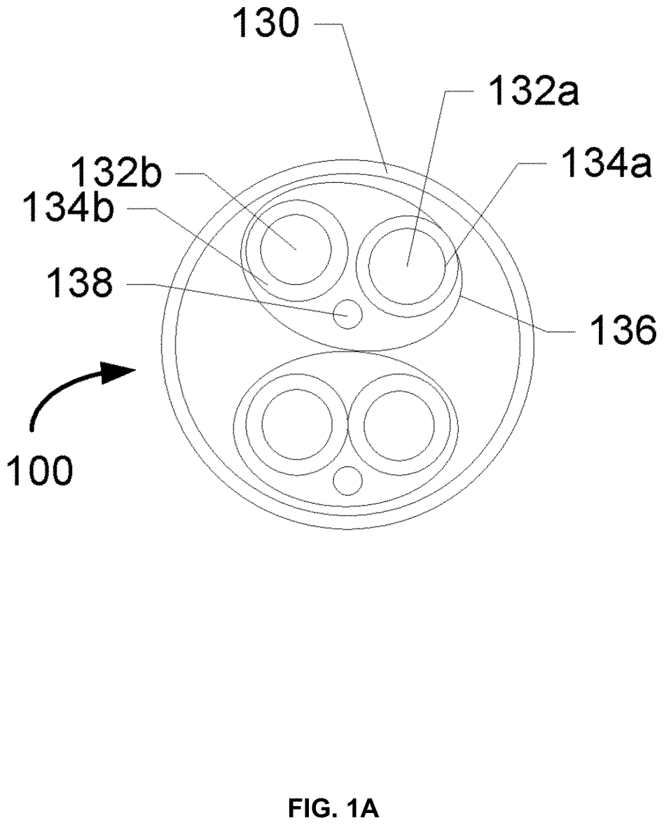

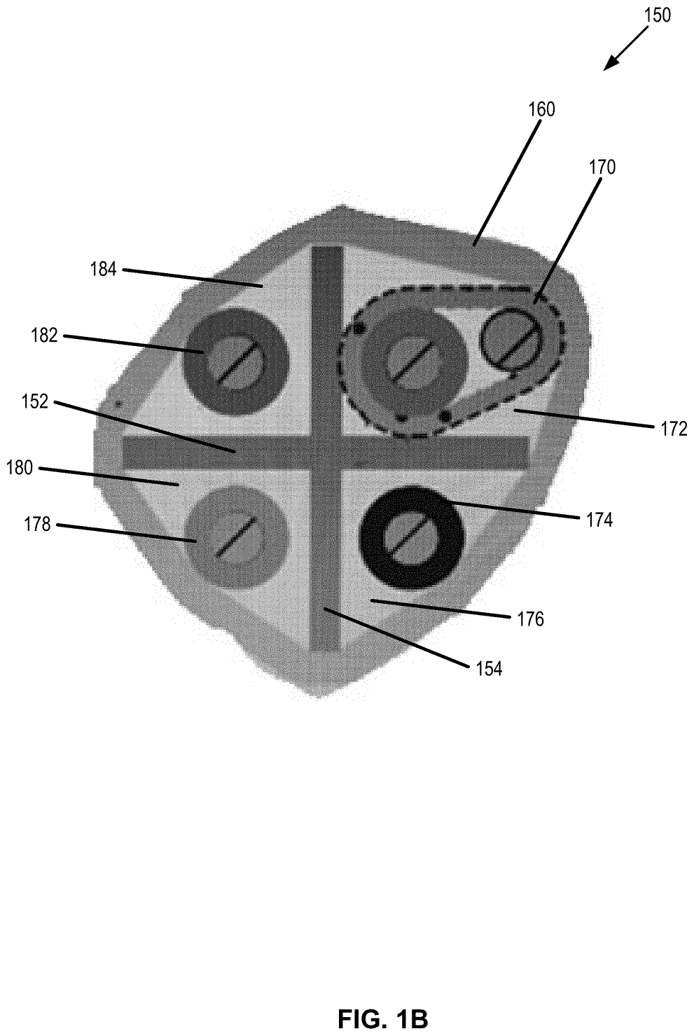

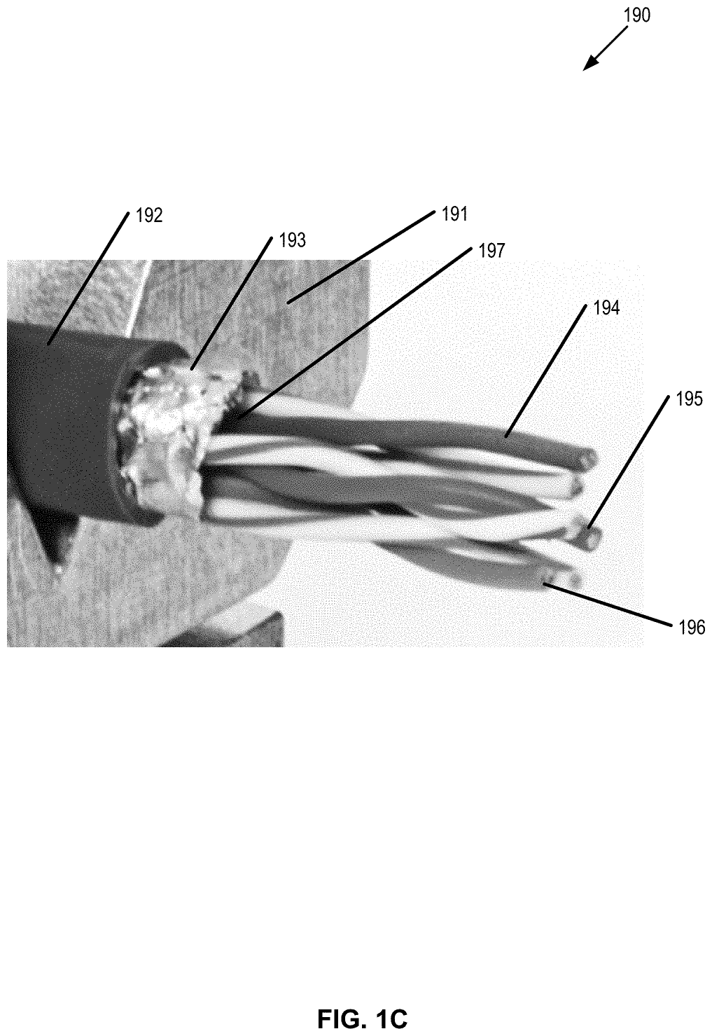

Further, electrical cables may not be perfectly circular in cross-section. Rather, the electrical cables may be oval, elliptical, or other non-circular shape in cross-section. In this regard, the surface of the electrical cable may deviate from being a perfect circle. For example, the electrical cable may have one or more interior wires, such as illustrated in FIGS. 1A-B, which may result in the electrical cable having a non-circular cross-sectional shape. The non-circular cross-sectional shape may not necessarily be considered a defect; rather, the surface deviations may simply a design feature of the electrical cable.

However, the non-circular cross-sectional shape may make removing of the protective shield on the electrical cable more difficult. In particular, because of this irregularity or deviations, it may be more difficult to control the laser/position of the electrical cable in order to ablate the protective shield (either by ablating a groove on the entire circumference of the protective shield or entirely ablating the protective shield around the circumference). In one implementation, a method and system are disclosed which senses the deviations or irregularities in the shape of the electrical cable and compensates for the deviations or irregularities in order to ablate the protective shield as desired.

In a particular implementation, at least one sensor senses the deviations or irregularities of the shape of the electrical cable. For example, a distance sensor may be used in order to measure a distance of the distance sensor (e.g., the distance sensor may be mounted in pre-determined relation on a carousel or other hardware on the apparatus) to the electrical cable (e.g., the electrical cable may be held in a holder so that the electrical cable is likewise in a positioned in pre-determined relation to the distance sensor). In practice, while the electrical cable is being held in at least one holder, the distance sensor may measure the distance to the surface of the protective shield of the electrical cable, and may forward the distance to a processor. The processor may analyze the distance as generated by the distance sensor in order to determine whether there is any need to modify operation (e.g., whether there is any deviation from a typical or expected distance).

Based on the distance measured, the processor may determine whether a movement of a compensation distance by one or both of a part of the laser system (such as the lens) or the holder should be performed in order to compensate for the deviation in the surface of the electrical cable. The processor may determine whether a compensation is warranted in one of several ways. In one way, the processor may compare the distance measured (e.g., 77 mm as generated by the distance sensor) with a typical or expected distance (e.g., 75 mm), determine a deviation (e.g., 2 mm), and correct the system accordingly (e.g., move the lens in the laser system by 2 mm closer to the electrical cable). In another way, the processor may directly correlate the distance as generated by the sensor (e.g., 77 mm) with a position that the lens should be moved to (e.g., command the motor to move the lens to a correlated position). In either way, the distance as generated by the sensor may be used to compensate for the irregularly shaped electrical cable.

For example, the typical or expected distance may comprise the distance at which the laser system is configured for ablating the surface of the protective shield. In particular, the laser system may comprise one or more lasers and one or more lenses. The laser(s) generate laser radiation (with the beams of the laser radiation being considered parallel or nearly parallel), which may then be focused using lens(es) to a focus (e.g., the point or area at which the laser radiation meet after reflection or refraction). In one implementation, the system may seek to position the focus in predetermined relation to the surface of the protective shield (e.g., the focus of the laser radiation is at a predetermined distance relative to the surface of the protective shield of the electrical cable).

In one implementation, the predetermined distance is zero (meaning that the focus intersects or is directly on the surface of the protective shield of the electrical cable). Alternatively, the predetermined distance is non-zero (meaning that the focus is outside of the electrical cable or inside the electrical cable (e.g., in an interior layer below the protective shield and closer to the center of the electrical cable)). Thus, in one implementation, the predetermined distance results in the focus being outside of the electrical cable (e.g., at least 0.1 mm outside of the electrical cable as measured from the surface of the protective shield of the electrical cable; at least 0.2 mm outside of the electrical cable as measured from the surface of the protective shield of the electrical cable, at least 0.3 mm outside of the electrical cable as measured from the surface of the protective shield of the electrical cable, at least 0.4 mm outside of the electrical cable as measured from the surface of the protective shield of the electrical cable, at least 0.5 mm outside of the electrical cable as measured from the surface of the protective shield of the electrical cable, at least 0.6 mm outside of the electrical cable as measured from the surface of the protective shield of the electrical cable, at least 0.7 mm outside of the electrical cable as measured from the surface of the protective shield of the electrical cable, at least 0.8 mm outside of the electrical cable as measured from the surface of the protective shield of the electrical cable, at least 0.9 mm outside of the electrical cable as measured from the surface of the protective shield of the electrical cable, at least 1 mm outside of the electrical cable as measured from the surface of the protective shield of the electrical cable, etc.). In an alternate implementation, the predetermined distance results in the focus being inside of the electrical cable (e.g., at least 0.1 mm inside of the electrical cable relative to the protective shield, at least 0.2 mm inside of the electrical cable relative to the protective shield, at least 0.3 mm inside of the electrical cable relative to the protective shield, at least 0.4 mm inside of the electrical cable relative to the protective shield, at least 0.5 mm inside of the electrical cable relative to the protective shield, at least 0.6 mm inside of the electrical cable relative to the protective shield, at least 0.7 mm inside of the electrical cable relative to the protective shield, at least 0.8 mm inside of the electrical cable relative to the protective shield, at least 0.9 mm inside of the electrical cable relative to the protective shield, at least 1 mm inside of the electrical cable relative to the protective shield, etc.).

Thus, in one implementation, the processor may access a memory (either separate from or as a part of the processor), with the memory storing the typical or expected difference (e.g., the memory stores the typical distance of 75 mm). The processor may then calculate the deviation from the typical or expected distance. In turn, the deviation may be used by the processor in order to compensate at least one aspect of the system in order for the focus of the laser radiation to be at the predetermined distance relative to the surface of the protective shield of the electrical cable. Alternatively, the processor may access a data construct that directly correlates the distance measurement with the amount to compensate (e.g., the absolute position of the lens).

Thus, in one example, the distance sensor may sense a distance measurement of 73 mm at a first point on the surface of the protective shield. Responsive to receipt of the distance measurement of 73 mm, the processor may calculate the deviation for the first point. For example, the processor may subtract the typical or expected difference from the sensed distance (e.g., 73 mm-75 mm=−2 mm). As another example, the processor may subtract the sensed distance from the typical or expected difference (e.g., 75 mm-73 mm=2 mm). Regardless, the processor may determine the deviation (e.g., the first point on the surface of the protective shield is 2 mm closer to the distance sensor than the typical or expected difference). As another example, the distance sensor may sense a distance measurement of 76 mm at a second point on the surface of the protective shield. Responsive to receipt of the distance measurement of 76 mm, the processor may calculate the deviation for the second point. For example, the processor may subtract the typical or expected difference from the sensed distance (e.g., 76 mm-75 mm=1 mm). As another example, the processor may subtract the sensed distance from the typical or expected difference (e.g., 75 mm-76 mm=−1 mm). Regardless, the processor may determine the deviation (e.g., the second point on the surface of the protective shield is 1 mm further away from the distance sensor than the typical or expected difference).

Given the distance (which may be used to determine the deviation from the typical or expected difference or which may be used for a direct correlation), the processor may control the modification of at least a part of the apparatus in order compensate for the distance measurement (e.g., compensate for the deviation) so that the focus of the laser radiation is at the predetermined distance relative to the surface of the protective shield of the electrical cable.

Various modifications are contemplated. In one implementation, the processor may control the position of one or both of at least a part of the laser system (e.g., the lens (or lenses) of the laser system) or the holder in order to compensate for the deviation between the typical or expected difference from the sensed distance so that the focus of the laser radiation is at the predetermined distance relative to the surface of the protective shield of the electrical cable. As one example, the processor may determine a compensation distance by determining the deviation between the typical or expected difference from the sensed distance (e.g., in the example above for the first point, the compensation distance is 2 mm). As another example, the processor may correlate a distance measurement to the electrical cable with a configuration of the system (e.g., a distance measurement of 73 mm correlates to a lens position of 20 mm; a distance measurement of 75 mm correlates to a lens position of 22 mm; a distance measurement of 77 mm correlates to a lens position of 24 mm; etc.).

In one implementation, the processor may control one or more motors in order to move one or both of the electrical cable or at least a part of a laser system the compensation distance relative to one another in order to position the focus of the laser radiation at the predetermined distance relative to the protective shield of the electrical cable. In a first specific implementation, the processor controls the one or more motors in order to move a part of the laser system the compensation distance, thereby positioning the focus at the predetermined distance relative to the protective shield of the electrical cable. For example, the processor may control one or more motors in order to move the lens(es) the compensation distance (e.g., move the lens(es) laterally in the direction toward or away from the electrical cable in order to move the focus the compensation distance so that the focus is at the predetermined distance from the protective shield of the electrical cable). In the example above at the first point where the deviation=2 mm closer to the distance sensor, the lens(es) may be moved 2 mm (e.g., the compensation distance) away from the electrical cable in order for the focus to be at the predetermined distance from the protective shield of the electrical cable. In the example above at the second point where the deviation=1 mm further from the distance sensor, the lens(es) may be moved 1 mm (e.g., the compensation distance) toward the electrical cable in order for the focus to be at the predetermined distance from the protective shield of the electrical cable. In this way, the focus of the laser radiation may be moved to compensate for the deviation. Put another way, distance from a distance sensor to various points along the circumference of the protective shield of the electrical may be measured. The system may dynamically update the position of the lens based on the distance measurements to the various points along the circumference of the protective shield in order for the focus on the laser radiation to be constant (or substantially constant) relative to the surface of the protective shield along the various points in the circumference of the protective shield.

In a second specific implementation, the processor may control one or more motors in order to move the electrical cable the compensation distance. For example, the processor may control the one or more motors in order to move the holder holding the electrical cable the compensation distance (e.g., laterally in the direction toward or away from the lens(es) in order to move the focus the compensation distance so that the focus is at the predetermined distance from the protective shield of the electrical cable). In the example above at the first point where the deviation=2 mm closer to the distance sensor, the holder of the electrical cable may be moved 2 mm (e.g., the compensation distance) closer to the lens(es) in order for the focus to be at the predetermined distance from the protective shield of the electrical cable. In the example above at the second point where the deviation=1 mm further from the distance sensor, the holder may be moved 1 mm (e.g., the compensation distance) away from the lens(es) in order for the focus to be at the predetermined distance from the protective shield of the electrical cable. Again, in this way, the focus of the laser radiation may be moved to compensate for the deviation. In a third specific implementation, the processor may control one or more motors in order to move both the at least a part of the laser system (e.g., the lens(es)) and the electrical cable so that the relative movement between the electrical cable at the lens(es) is the compensation distance so that the focus of the laser radiation may be moved to compensate for the deviation.

In one implementation, the distance sensor, the laser(s) and the lens(s) and the at least one holder move relative to one another. In a first specific implementation, the distance sensor, the laser(s) and the lens(s) are mounted on a carousel which revolves around the stationary holder. In a second specific implementation, the holder moves and the distance sensor, the laser(s) and the lens(s) remain stationary. In a third specific implementation, the holder moves and the distance sensor, the laser(s) and the lens(s) move relative to one another. Thus, through the relative movement, the deviation along a circumference of the surface of the protective shield may be determined. For example, the deviation may be calculated along at least 100 points evenly distributed along the circumference of the surface of the protective shield, at least 200 points evenly distributed along the circumference of the surface of the protective shield, at least 300 points evenly distributed along the circumference of the surface of the protective shield, at least 400 points evenly distributed along the circumference of the surface of the protective shield, etc. With the deviation determined at each of the respective points, at least a part of the system may be modified in order to compensate for the deviation (e.g., at each of the respective points, the lens may be moved to compensate for the deviation). In other words, at each of the respective points along the circumference of the surface of the protective shield, the processor may dynamically determine how to configure at least a part of the system (e.g., the lens being moved) in order to maintain the focus of the laser radiation to be in predetermined relation with each of the respective points (e.g., the focus is 0.5 mm outside of the electrical cable at least of the respective points).

As discussed above, the electrical cable may have different tiers or layers. For example, the electrical cable may have a protective shield tier in which a protective shield is wrapped thereon. As another example, the electrical cable may have an insulating tier in which an insulating layer is wrapped thereon. As still another example, the electrical cable may have an external tier external to the protective shield tier. In one implementation, the wrapping of the protective shield in the protective tier results in a section where there is an overlap, namely that wrapping the protective shield results in two layers of the protective shield. For example, a metal foil shield may be wrapped around an insulator (e.g., around the insulating tier or insulating layer) such that a section of the metal foil tier may have two layers of metal foil shield (e.g., an upper protective shield layer, such as an upper foil metal shield layer, and a lower protective shield layer, such as a lower metal foil shield layer, so that in at least a part of the circumference of the protective shield tier, there is the upper protective shield layer on top of the lower protective shield layer). This overlap may make removing the protective shield in the protective shield tier more difficult. In particular, it may be more difficult to gauge the application of the laser radiation in order to remove the protective shield while avoiding damaging an inner tier, such as the insulating layer underneath the protective shield.

Thus, in one implementation, a method and apparatus are disclosed in which the external tier (such as an external protective layer made of rubber) is removed, such as by using a knife or other cutting implement. Other means by which to remove the external tier are contemplated. After which, there is an exposed section of the protective shield. That exposed section of the protective shield may include, along at least a part of the circumference, overlapping protective shield layers (e.g., an upper protective shield layer at least partly overlapping a lower protective shield layer). The laser radiation is applied to a part of the exposed section of the protective shield, thereby creating a groove. In one implementation, after applying the laser radiation, the groove is on the surface of the protective shield layer (so that the insulating layer underneath is still not exposed). In an alternate implementation, after applying the laser radiation, the groove goes through at least a part of an upper protective shield layer but does not go entirely through the lower protective shield layer.

In this regard, after the groove is created, there are two parts of the exposed section of the protective shield, including a first part of the exposed section of the protective shield on one side of the groove and a second part of the exposed section of the protective shield on the other side of the groove. A holder may physically contact and hold the first part of the exposed section of the protective shield on the one side of the groove (either before the groove is created or after the groove is created). A gripper (interchangeably referred to as a gripping mechanism) may physically contact and hold or grip the second part of the exposed section of the protective shield on the other side of the groove (again either before the groove is created or after the groove is created). While the holder contacts/holds the first part and the gripper contacts/grips the second part, a twisting movement (e.g., a twisting motion) may be generated, whereby the twisting movement of the first part of the exposed section of the protective shield and the second part of the exposed section of the protective shield is generated relative to one another. The twisting movement results in generating shear stress in the groove thereby separating the second part of the exposed section of the protective shield from the first part of the exposed section of the protective shield.

In one implementation, the twisting movement is performed by the gripper (while contacting/twisting the second part of the exposed section of the protective shield) with the holder remaining stationary (while contacting/holding the first part of the exposed section of the protective shield). In another implementation, the twisting movement is performed by the holder (while contacting/twisting the first part of the exposed section of the protective shield) with the gripper remaining stationary (while contacting/gripping the second part of the exposed section of the protective shield). In still another implementation, the twisting movement is performed by both the gripper and the holder (e.g., the gripper twists in one direction and the holder twists in the opposite direction, both contacting/twisting the respective exposed section of the protective shield).

Further, in one implementation, the twisting movement may comprise a series of twisting movements, including a first twisting movement in a first direction and a second twisting movement in a second direction, with the second direction being opposite the first direction. For example, with the holder holding the first part of the exposed section, the gripper may perform a first clockwise twisting movement on the second part of the exposed section and thereafter may perform a second counter-clockwise twisting movement on the second part of the exposed section. As another example, with the gripper gripping the second part of the exposed section, the holder may perform a first counter-clockwise twisting movement on the first part of the exposed section and thereafter may perform a second clockwise twisting movement on the first part of the exposed section.

In one implementation, the twisting movement is at least greater than an entire revolution (e.g., at least greater than a 360° revolution, at least greater than a 370° revolution, at least greater than a 380° revolution, at least greater than a 390° revolution, at least greater than a 400° revolution, at least greater than a 410° revolution, at least greater than a 540° revolution, at least greater than a 630° revolution, at least greater than a 720° revolution, at least greater than an 810° revolution, at least greater than a 900° revolution, at least greater than a 990° revolution, at least greater than a 1080° revolution, etc.). By performing the twisting movement at least greater than one revolution (while holding both the first part and the second part of the exposed section of the protective shield), a crack may be created in the protective shield, growing with the rotation (e.g., greater than 360°) and thereby ripping the part of the protective shield (such as the lower protective shield layer) that has not been ablated at all by the laser (or has been ablated less than the upper protective shield layer).

Reference is made to FIG. 1A that illustrates an electrical cable cross section according to an example, such as illustrated in U.S. Pat. No. 10,476,245, incorporated by reference herein in its entirety. A shielded twisted pair (STP) cable 100 could include a shielding/screening sleeve or sleeves 130 and a plurality of twisted pair inner wires. Each of inner wires 132a and 132b is covered by isolation 134a and 134b. Inner wires 132a and 132b represent a twisted pair that could be further covered by a metal foil shield or sleeve 136. The particular cable 100 includes two sets of twisted pair wires. Each twisted pair could include an additional inner wire 138. Inner wire 138 may serve as a drain wire.

FIG. 1B illustrates a cross section of an electrical cable 150 according to a second example. As shown, a protective shield 160 may encircle an interior of the electrical cable. The interior may comprise dividers 152, 154, which may result in one or more interior areas (e.g., as shown in FIG. B, dividers 152, 154 result in four quadrants). Each respective interior area may include wiring 170, 174, 179, 182 and corresponding free space 172, 176, 180, 184. As shown in FIG. 1B, the curvature of the protective shield 160 is not circular. Rather, the curvature in the circumference of the protective shield 160 may vary based on the wiring 170, 174, 179, 182 and/or corresponding free space 172, 176, 180, 184.

FIG. 1C illustrates a perspective view 190 of an electrical cable after the protective shield 193 has been removed from a part of the electrical cable. As shown, another layer 192, exterior to the protective shield 193, is also removed. Further, the electrical cable is held in holder 191. After removal of the protective shield 193, interior wires 194, 195, 196, 197 are exposed.

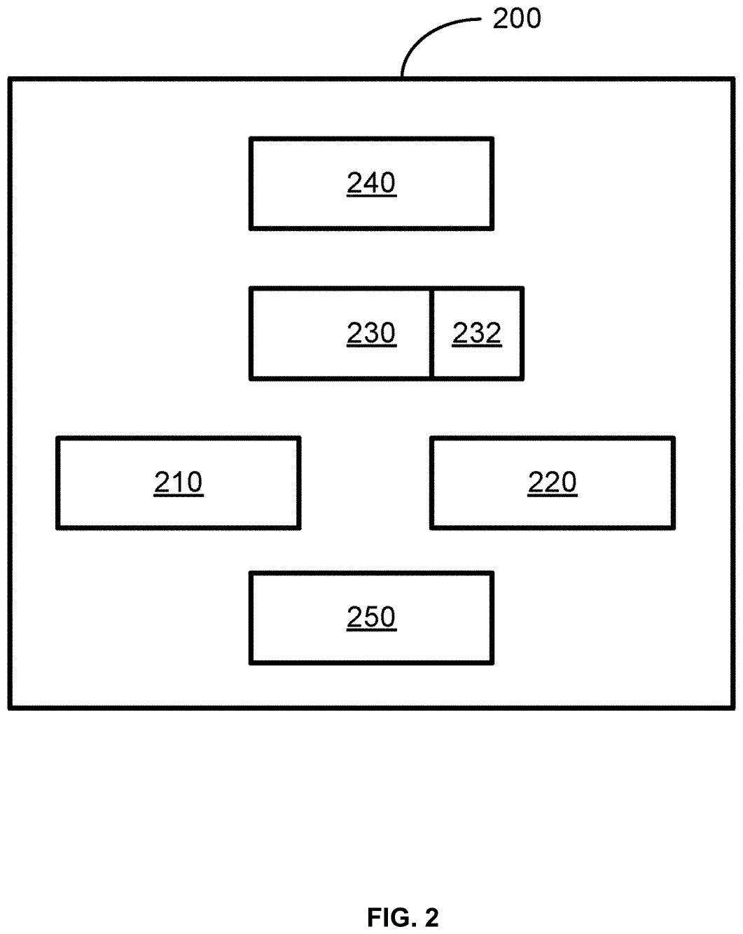

FIG. 2 is a schematic illustration of a simplified block diagram of an example of a metal foil shield removal system, which is an example of a protective shield removal system. Metal foil shield removal system 200 includes a holder mechanism or simply a holder 210 configured to hold an electrical cable such that a segment of the electrical cable metal foil shield to be removed protrudes from holder 210; a metal foil shield ablation system 220, a control computer 230, which could be a personal computer (PC), a process monitoring system 240 and a gripper 250. Control computer 230 controls operation of all units and devices of the metal foil removal system 200 or simply system 200.

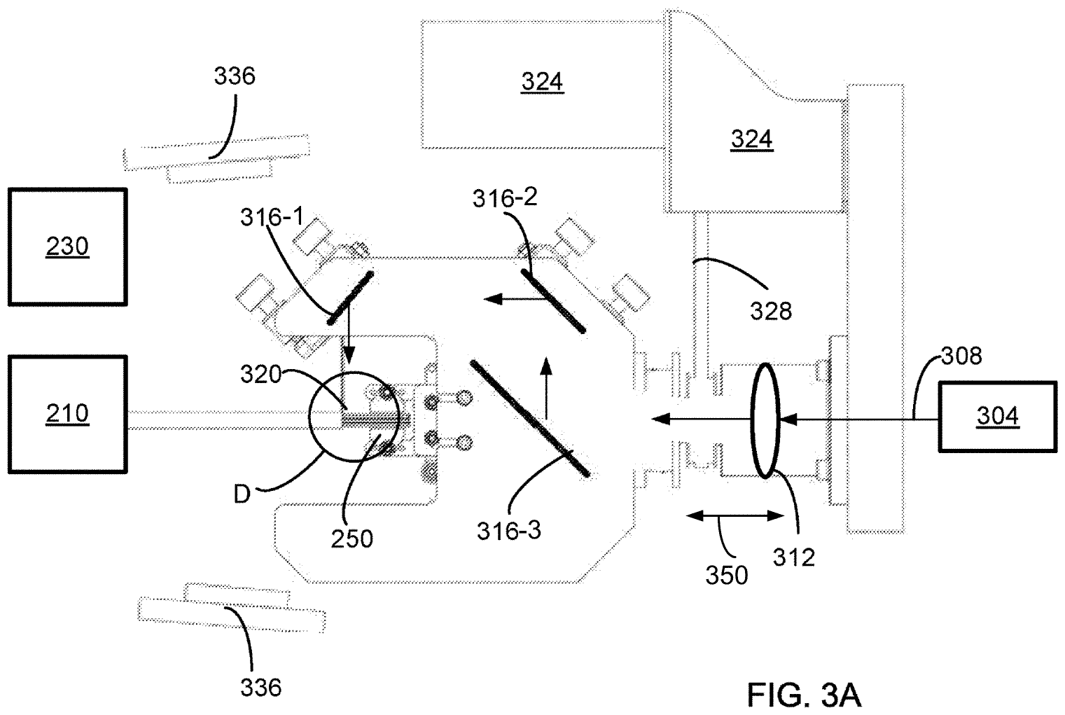

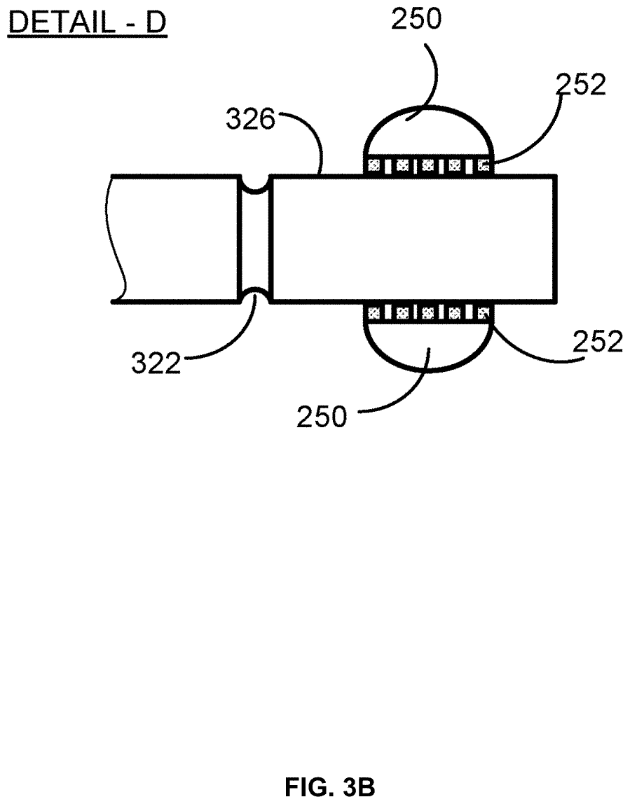

FIG. 3A is a schematic illustration of an example of a metal foil removal system. Metal or foil shield ablation system 220 includes a laser 304 configured to provide a laser radiation beam 308 and an optical system that includes a lens 312 and a number of folding mirrors 316-1, 316-2, 316-3. Laser 304 could be such as a q-switched Pulse/CW fiber laser, commercially available from Optisiv Ltd. Kibbutz Einat 48805, Israel. (Fiber laser is a laser in which the active gain medium is an optical fiber doped with rare-earth elements such as erbium, ytterbium, neodymium, dysprosium, praseodymium, and thulium.) The optical system may be attached to a common mount. In particular, the lens may concentrate the laser radiation on surface of protective layer and at least one motor rotates the common mount to scan the laser beam on the surface of the protective layer of the electrical cable. Linear movement of the lens may support ablation of different size electrical cables. Control of laser beam power and pulse rate provides tools to gradually control the energy density. The fiber laser could be operated either in Pulse or Continuous Wave (CW) mode. Use of a fiber laser has some advantages over solid state lasers such as Nd-YAG, and gas lasers such as CO₂. Fiber laser has a compact size, low cost, simple maintenance, and long lifetime, all of these are important for industrial use. The fiber laser in pulse mode generates pulses with duration from 300 psec to 500 nsec and peak power of 1 kw to 500 kw. The high peak power supports metal foil shield material removal by ablation without heating wire insulation layers located beneath the shield. Ablation produces a clean groove at different shield thickness. Fiber laser could be operated at a high Continuous Repetition Rate from a few KHz to 500 KHz, in pulse-on-demand mode or issue a burst of pulses. In some examples the fiber laser is providing laser radiation in continuous in an alternating or sequential mode where a number of pulses are followed by a continuous mode of operation and vice-versa. High power emitted by the fiber laser supports efficient frequency conversion. Different wavelength such as 255-270 nanometers, 510-540 nanometers and 1020-1080 nanometers have been tested. Ablation of the metal foil shield was obtained at wavelengths of 1030 nm, 1064 nm, 532 nm, 355 nm or 266 nm.

The optical system is configured to shape the laser radiation beam 308 and concentrate the laser radiation beam 308 on surface 326 (Detail D) of the metal foil shield 320 with power sufficient to ablate at least some of the metal foil shield and form a groove 322 (Detail D) on surface 326 of the metal foil shield 320 protruding from holder 210. Motor 324 is operated to rotate the assembly of folding mirrors 316-1, 316-2, 316-3 around metal foil shield 320 to scan laser radiation beam 308 such that laser radiation beam 308 would be concentrated on the surface of metal foil shield 320. Rotation of the mirrors 316-1, 316-2, 316-3 assembly with properly concentrated laser radiation power ablates a certain depth of the metal foil shield 320 and ablates a groove 322. The depth of the groove could be 1.0 to 7.0 micron and the laser radiation power could be 1 kW to 500 kW.

In some examples, the speed of rotation of the mirror assembly that delivers laser radiation beam 308 to the metal foil shield can be used to control the amount of laser power delivered to the metal foil shield. Control of the laser energy could be used to determine the depth of the groove 322 and corresponding reduction in the strength of the metal foil shield.

Monitoring system 240 can include one or more video cameras 332 and an image processing module 336. The video cameras can be placed in several locations around the perimeter or circumference of the electrical cable. Video cameras 332 are configured to capture or help to observe the segment of the electrical cable that protrudes from holder 210 and in particular help to observe one or both of the groove 322 ablation and the segment of metal foil shield separation. Each of the cameras 332 can deliver the captured image to an image processing unit 336 that is configured to analyze the video images. The information derived from processing of the images received may be delivered as a feedback to the control computer 230. In this regard, the control computer, using the feedback, may control, among one or more other operations, the removal of the segment of the protective layer from the remainder of the electrical cable.

Metal foil removal system 200 further includes a gripper 250 configured to grip a segment of metal foil shield 320 of the electrical cable shield or foil that protrudes from holder 210 and is proximate to gripper 250, twist the segment of metal foil shield 320 such as to generate a shear stress in the groove 322 (Detail D) and separate the segment of metal foil shield 320 of the electrical cable that protrudes from holder 210 from the rest of the electrical cable. In addition to twisting movement, separation of the segment of the electrical cable that protrudes from holder 210 is performed by linear movement of holder 210. In order to avoid damage to the electrical cable gripper 250 includes a plurality of soft and sticky fingers 252 (Detail D) configured to grip and hold the segment of electrical cable that protrudes from the holder and is proximal to gripper 250. Motor 324 could also provide the desired movement to gripper 250. Pressurized air activated or release the foil from the gripper.

Various types of processing functionality are contemplated. One example of a controller or processing functionality comprises control computer 230, which may comprise a personal computer (PC) including a processor and memory. Control computer 230 could communicate with other system 200 devices via industry standard communication buses and protocols. Different types of fixed 232 or removable memory such as RAM, ROM, magnetic media, optical media, bubble memory, FLASH memory, EPROM, EEPROM, etc. removable memory could be used to record for repeat use electrical cable parameters and system 200 operating parameters. Control computer 230 could also include a display and a keyboard, facilitating display and entry of information that could be required to operate system 200. Control computer 230 may also be connected to a local area network and/or Internet.

Metal foil removal system 200 is adapted to receive electrical cables of different size (diameter or perimeter). Lens 312 could be displaced or moved to maintain a laser radiation concentration point on surface 326 (Detail D) of metal foil shield 320 of electrical cables with different size. Motor 324 could also be configured to displace or move lens 312 to maintain a laser radiation concentration point on surface 326 of metal foil shields of electrical cables with different size. Lens 312 displacement or movement also supports control of the concentration of the laser radiation on surface of the metal shield of the electrical cable. As discussed above, lens 312 may be displaced or moved in lateral direction 350 (such as illustrated in FIG. 3A) in order to compensate for deviations in the distance of the electrical cable from a typical distance. In this regard, control computer 230 may determine, based on the deviations in the distance of the electrical cable from a typical distance or based on an absolute distance of the sensor to the electrical cable, an amount to displace or move lens 312. Responsive to this determination, control computer 230 may command motor 324 to move lens 312 the determined amount to displace the lens 312. The rotating or scanning mirror system supports uniform energy density distribution along the metal foil shield perimeter.

Prior to system 200 operation, a process may be performed to determine laser radiation power sufficient to ablate a groove 322 in the metal foil shield 320 and separate the segment of metal shield from the rest of the electrical cable. To determine the laser radiation power sufficient to ablate a groove 322 in metal foil shield 320, a cut to measure and stripped from its outer jacket and braded shield electrical cable is inserted into holder 210. To facilitate the process, a set of parameters related to the sample cable inserted in holder 210 of system 200 may be entered into control computer 230. Alternatively, electrical cable parameters may be called from a look-up table stored in control computer 230 memory. The electrical cable parameters could be such as metal foil shield size, thickness, foil material and others. Laser 304 is activated and mirror assembly is rotated to ablate a circumferential groove 322 in the metal foil shield 320. The laser power is gradually increased until the laser power ablates a grove with sufficient depth supporting easy protruding metal foil shield segment separation. The determined electrical cable metal foil shield removal parameters could include mirror assembly rotation speed, pulse duration and repetition rate, pulse peak power and others.

The determined electrical cable metal foil shield removal parameters could be entered into control computer 230 (Block 404) and the process of metal foil shield removal for a batch of electrical cables could be initiated. Cut to size electrical cable stripped from its outer jacket and a braded shield if such exists, is inserted (Block 408) into system 200 where holder 210 picks-up the electrical cable and advances it to a desired length that could be 1.0 to 250 mm Lens 312 is displaced (Bloc 412) to adapt location of the concentrate the laser radiation beam 308 to the size (diameter) of the electrical cable and locate concentrate the laser radiation beam 308 on surface 326 of the metal foil shield 320. Control computer 230 activates laser 304 and motor 324 that rotates the mirror assembly (Block 416). Since laser 304 is activated and emits laser radiation beam 308, rotation of mirror assembly ablates a groove 322 in the metal foil shield (Block 420). Laser 304 is deactivated after one full mirror assembly rotation. In some examples, there could be more than one full mirror assembly rotation. Following completion of one full mirror assembly rotation, control computer 230 activates the pneumatic or electrical system and gripper 250 to grip the protruding (proximate) segment of metal foil shield (Block 424) located after the groove. Next, gripper 250 is rotated. Sticky fingers 252 that firmly grip the metal-foil shield after the groove 322 force the segment of metal foil shield located after the groove 322 to rotate and generate shear stress (Block 428) in the groove 322 to tear the segment of metal foil shield.

Following the tear or separation of the segment of metal foil shield, holder 210 pulls the electrical cable back (Block 432), to leave the removed segment of metal foil shield inside gripper 250. Gripper 250 is deactivated and a pressurized air pushes the removed segment of metal foil shield out of gripper 250. Next metal foil shield removal cycle could start.

In course of the process, video camera 332 captures images of the groove 322 and the segment of metal foil shield following the groove 322 and communicates the images to control computer 230 that includes software adapted to perform analyses related to the accuracy of the place of the groove 322 and also verifies that there is not metal material left on the electrical cable.

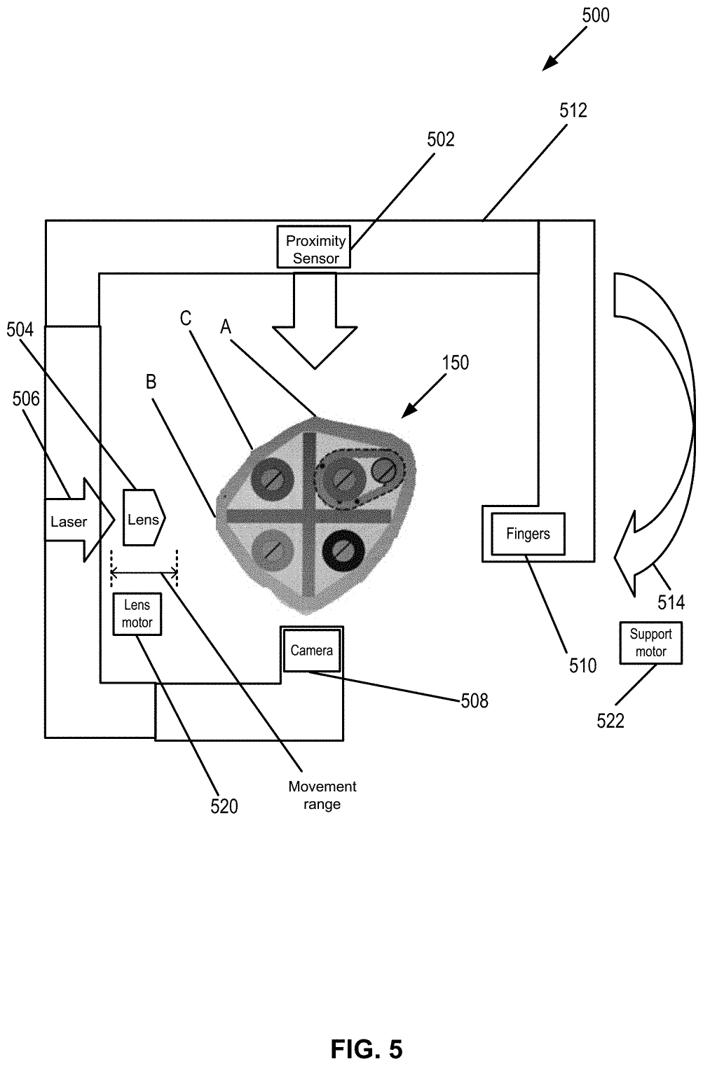

As discussed above, in one implementation, the system may dynamically update to compensate for irregularities in the electrical cable, such as a protective shield layer surface of the electrical cable that is not circular in cross section. FIG. 5 is an example schematic illustration 500 of sensing at least one aspect of the protective shield (such as distance of a sensor to the surface of the protective shield) and modifying at least one aspect of operation to compensate for the sensed aspect (such as moving the focal point of the laser system relative to the electrical cable). The cross section of the electrical cable 150 (illustrated in FIG. 5) may be held in a holder (not shown in FIG. 5). In one implementation, a single holder may hold the electrical cable 150 while the distance measurement from the proximity sensor is performed and while the position of the lens 504 is adjusted and the laser radiation is applied to the surface of the electrical cable. Alternatively, a first holder may hold the electrical cable 150 while the distance measurement from the proximity sensor is performed and a second holder may hold the electrical cable 150 while the lens is adjusted and the laser radiation is applied to the surface of the electrical cable. In this regard, at least one holder, such as a single holder or multiple holders, may be used in holding the electrical cable 150.

A support structure 512 may support various elements, such as proximity sensor 502, lens, 504, laser 506, camera 508, and fingers 510. One example of a support structure is a carousel, or other rotating type structure. Support structure 512 may rotate, such as in a clockwise direction 514, via support motor 522. Alternatively, support structure 512 may rotate in a counter-clockwise direction. Further, as shown in FIG. 5, proximity sensor 502 is measuring the distance from the proximity sensor 502 to point “A” on the surface of the protective shield. This measurement may be sent to a processor (not shown in FIG. 5), which may determine the position of the lens when support structure 512 rotates such that point “A” is in front of lens 504 (as shown in FIG. 5, point “B” on the surface of the protective shield is in front of lens 504). As discussed above, for compensation, lens 504 may be moved (such as by lens motor 520, which may move laterally along a movement range) closer to or further away from the electrical cable.

Further, camera 508 may be supported on support structure 512. The camera may be used for any one, any combination, or all of: obtain an image after the laser radiation has been applied in order for the processor to determine whether the cut has been made to the protective shield (e.g., identify a change in color in order to determine whether cut has been made); obtain an image for the processor to determine at what location the foil starts (e.g., identifying at what location the foil starts may assist in the processor controlling a motor, such as support motor 522, thereby controlling where to place the fingers 510 in order to peel the foil); after the peeling operation by the fingers 510 has been performed, obtain an image so that the processor may determine that the inside layer (e.g., the wires) are exposed.

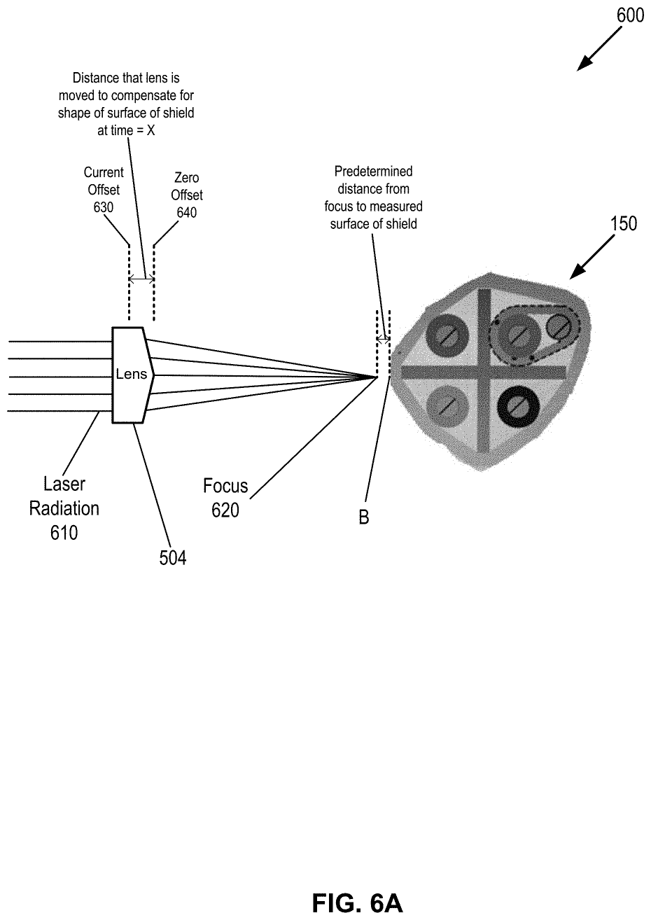

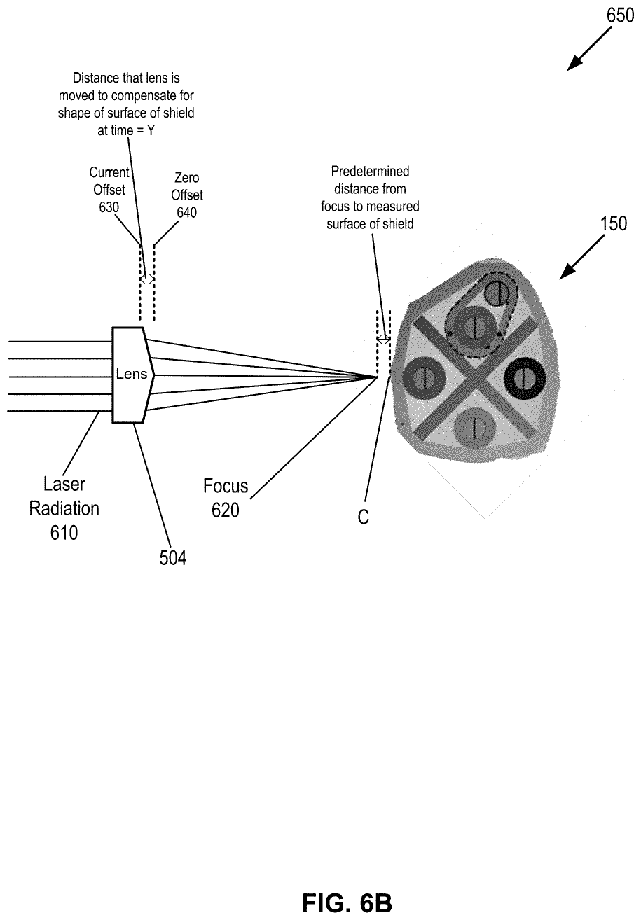

FIG. 6A is a first schematic illustration 600 of moving the lens 504 relative to the electrical cable 150 in order to compensate for variations at a first point (point “B”) of the surface of the electrical cable 150. As discussed above, the compensation may be relative (e.g., relative to a zero position or zero offset of the lens) or may be absolute (e.g., an absolute position of the lens). FIG. 6A illustrates relative compensation, in which lens 504 is at a current offset 630 (relative to zero offset 640), which is distance (at time=X) that the lens is moved to compensate for the shape of the surface of the protective shield. Because of the movement of lens 504, the focus 620 of the laser radiation 610 is a predetermined distance from the surface of the protective shield. FIG. 6A does not depict a mirror. Alternatively, one or more mirrors may be used. For example, lens 504 may be placed between mirrors 316-1 and 316-2.

FIG. 6B is a second schematic illustration 650 of moving the lens 504 relative to the electrical cable in order to compensate for variations in at a second point (point “C”) of the surface of the electrical cable 150. FIG. 6B illustrates relative compensation, in which lens 504 is at a current offset 630 (relative to zero offset 640), which is distance (at time=Y) that the lens is moved to compensate for the shape of the surface of the protective shield. As shown, the distance between current offset 630 and zero offset 640 in FIG. 6B is less than the distance between current offset 630 and zero offset 640 in FIG. 6A. This is due to the movement of lens 504 closer to the electrical cable 150 in order to compensate for the variations in the surface of the electrical cable 150. This movement or change in the position of lens 504 results in a consistent placement of the focus 620 relative to the surface of the electrical cable. In particular, in both FIG. 6A and FIG. 6B, lens 504 is positioned such that the focus 620 is the same predetermined distance from the surface of the shield (e.g., both in FIG. 6A and FIG. 6B, focus is 0.5 mm from the surface of the protective shield). In this regard, because of the movement of lens 504, the focus 620 of the laser radiation 610 is the predetermined distance from the surface of the protective shield so that the laser radiation 610 may be consistently applied to the surface of the protective shield.

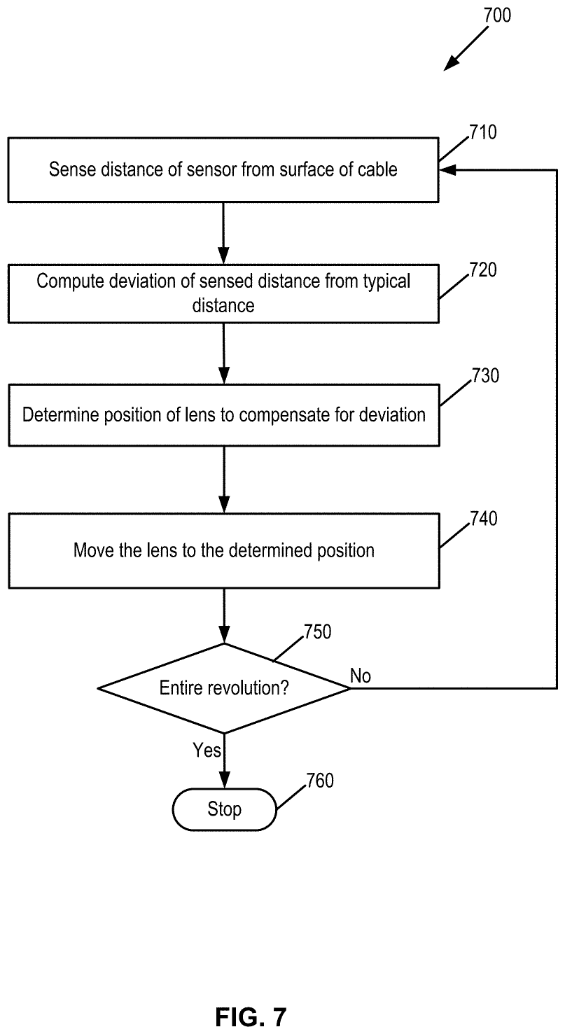

FIG. 7 is a flowchart 700 illustrating a process of compensating for deviations in the surface of the protective shield according to an example. At 710, the distance from the sensor to the surface of the electrical cable is sensed. At 720, the deviation of the sensed distance from the typical distance is computed. At 730, the position of the lens to compensate for the deviation is determined. At 740, the processor commands a motor to move the lens to the determined position. Alternatively, a direct correlation between the sensed distance and a position of the lens may be computed.

As discussed above, the distance at a plurality of discrete points along the surface of the electrical cable (such as at least 50 points, etc.) may be detected, and the lens may be moved to compensate accordingly. As such, at 750, it is determined whether an entire revolution has been performed. If yes, flowchart 700 stops at 760. If not, flowchart 700 loops back to 710.

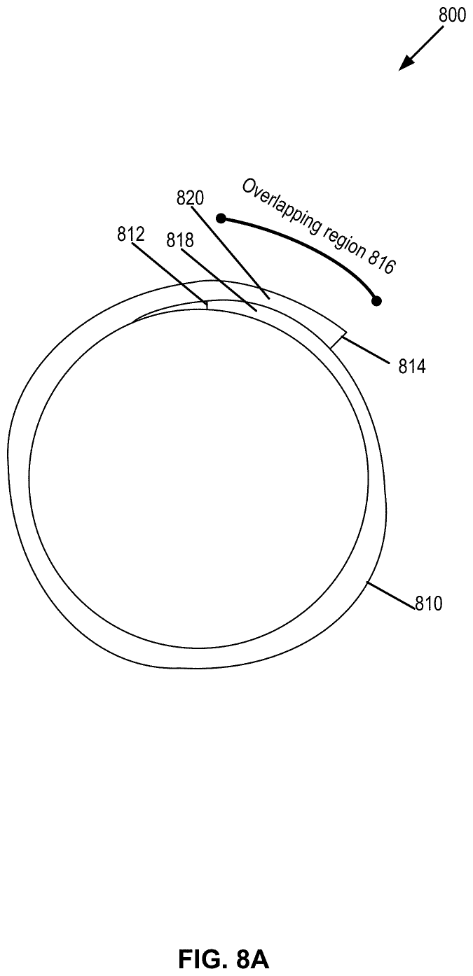

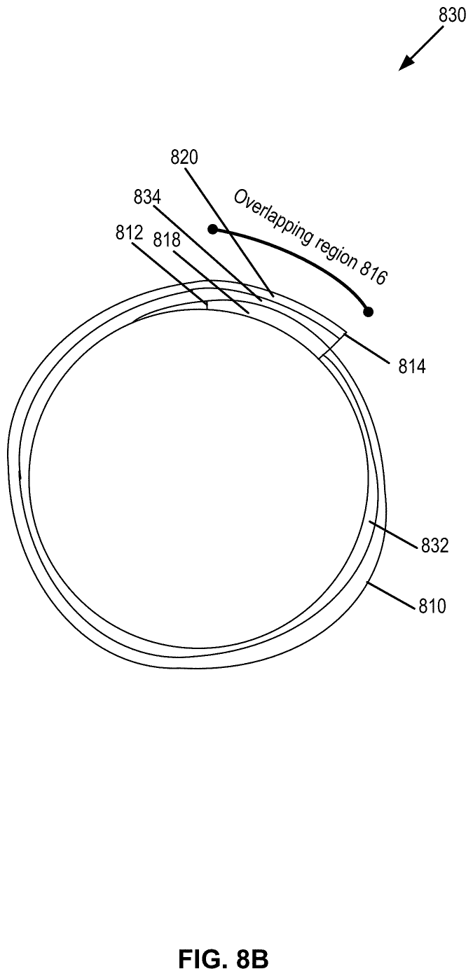

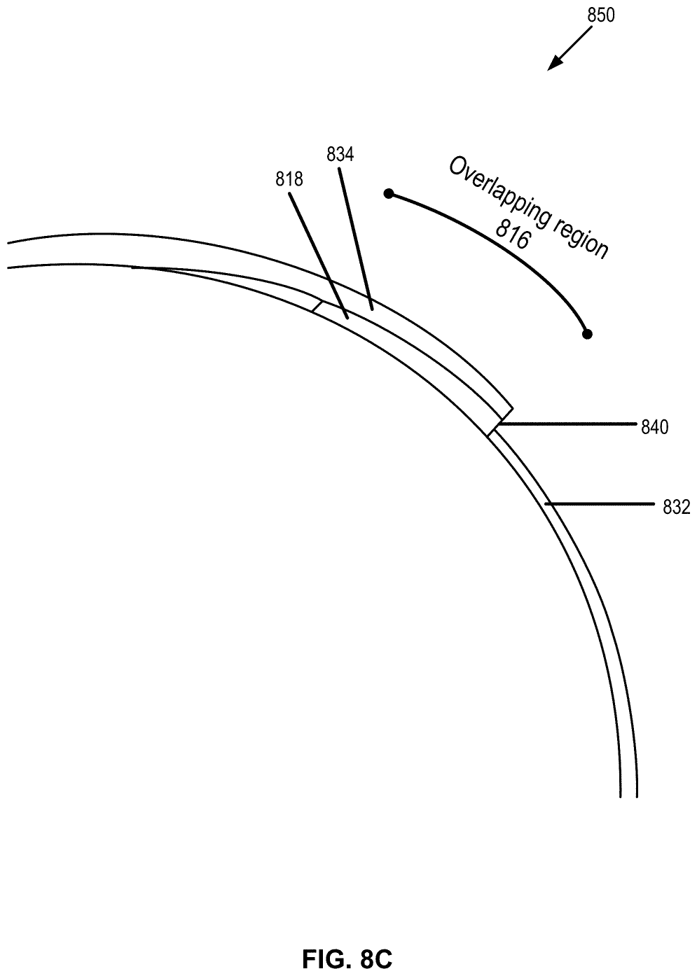

As discussed above, the protective shield tier in the electrical cable may have more than one protective shield layer (e.g., due to wrapping of the protective shield). This is illustrated, for example, in FIG. 8A, which is a cross sectional view 800 of the protective shield 810 prior to laser ablating. Protective shield 810 is shown as non-uniform in thickness. This is merely for illustration purposes. Alternatively, protective shield 810 may be uniform in thickness along some or all of its length. The protective shield 810 (with ends 812, 814) is wrapped around an inner layer, which may result in an overlapping region 816 of the protective shield 810. In this way, the overlapping region 816 includes a lower protective shield layer 818 and an upper protective shield layer 820 are created. Overlapping region 816 is not necessarily drawn to scale but is shown for illustration purposes only that a section of the protective shield tier may have a greater thickness due to overlap.

FIG. 8B is a cross sectional view 830 of the protective shield, including illustrating both pre and post laser ablating. In particular, in one implementation, after laser ablating, a part (but not all) of the protective shield 810 is ablated (represented as 832). As shown, ablated protective shield 832 is thinner than protective shield 810.

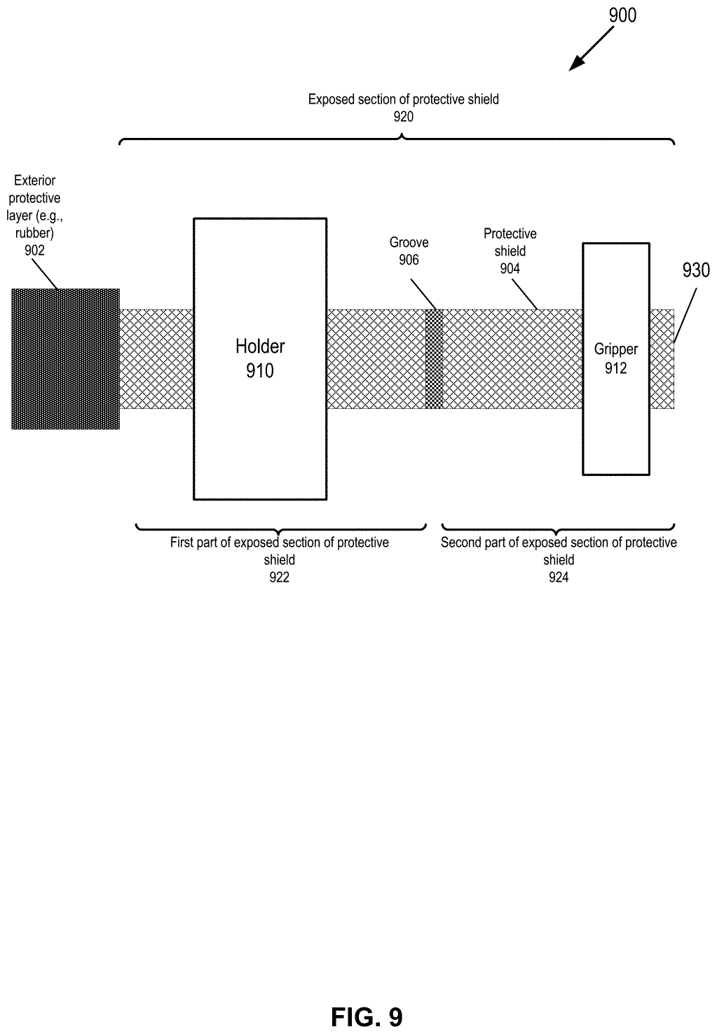

FIG. 8C is an expanded view 850 of the protective shield 832 after laser ablating, including illustrating an overlapping region 816 of the protective shield remains after laser ablating. As shown, upper protective shield layer 820 is ablated to become ablated upper protective shield layer 834, which is thinner than upper protective shield layer 820. Further, lower protective shield layer 818 is not affected by the ablation. Rather, the thickness of lower protective shield layer 818 remains the same after laser ablating. At junction 840, it is illustrated that ablated protective shield 832 is thinner than lower protective shield layer 818. Nevertheless, because a part of the protective shield is weakened, the twisting movement (e.g., holding the protective shield on both sides of the groove during twisting, as discussed in FIG. 9) results in the weakened part of the protective shield to crack or rip, with the continued twisting movement cracking or ripping other sections of the protective shield, including lower protective shield layer 818 (which may not be affected by ablation). In this way, even though lower protective shield layer 818 is not subject to ablation, the twisting movement results in its ripping.

FIG. 9 is a top view 900 illustrating the holder 910 and the gripper 912 both physically contacting the exposed section of the protective shield 920 in order to perform the twisting movement. As discussed above, exterior protective layer (e.g., rubber) 902 may be removed by a knife or other type of cutting tool, resulting in the exposed section of the protective shield 920. Laser radiation may be applied to part or an entire circumference of the exposed section of the protective shield 920, resulting in groove 906. Holder 910 may physically contact protective shield 904 at a first part of the exposed section of the protective shield 922, and gripper 912 may physically contact protective shield 904 at a second part of the exposed section of the protective shield 924. The physical contact of the gripper may be at an end 930 of the electrical cable, or may be proximate to the end 930 of the electrical cable. While the holder 910 is physically contacting and holding at least a part of the first part of the exposed section of the protective shield 922 and while the gripper is physically contacting and holding at least a part of the second part of the exposed section of the protective shield 924, a twisting movement is generated. The twisting movement may be generated by the gripper 912 (with the holder 910 remaining stationary), the holder 910 (with the gripper 912 remaining stationary) or both the gripper 912 and the holder 910 generating the twisting movement. Because both the holder 910 and the gripper 912 are contacting a part of the exposed section of the protective shield 920 on either side of groove 906 and because of the twisting movement, the protective shield 904 may be ripped apart even if the protective shield 904 under groove 906 remains and/or even if one or more protective layers for the protective shield 904 under groove 906 is unablated.

The twisting movement may be performed in one or both of a clockwise direction and a counter-clockwise direction. Further, the twisting movement may be performed in one or both of the clockwise direction and the counter-clockwise direction for more than 360° (e.g., in one or both of the clockwise direction and the counter-clockwise direction for at least greater than a 360° revolution, at least greater than a 540° revolution, at least greater than a 630° revolution, at least greater than a 720° revolution, at least greater than an 810° revolution, at least greater than a 900° revolution, at least greater than a 990° revolution, at least greater than a 1080° revolution, etc.).

In one implementation, the revolutions in the clockwise and/or counter clockwise directions may be greater than 360° but less than 1080°, may be greater than 540° but less than 1440°, may be greater than 540° but less than 1080°, etc. In particular, the revolutions may first be in one of the clockwise direction or counter clockwise direction, and then in the other of the clockwise direction or counter clockwise direction. Further, both the clockwise direction and the counter clockwise direction may be greater than 360° but less than 540°.

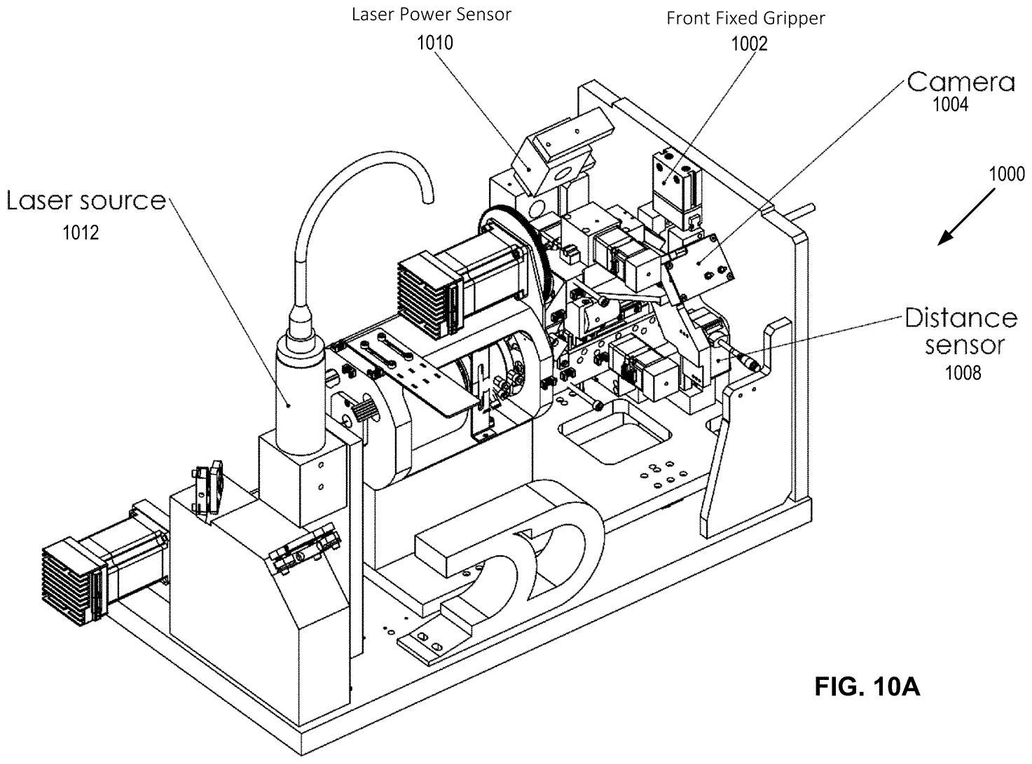

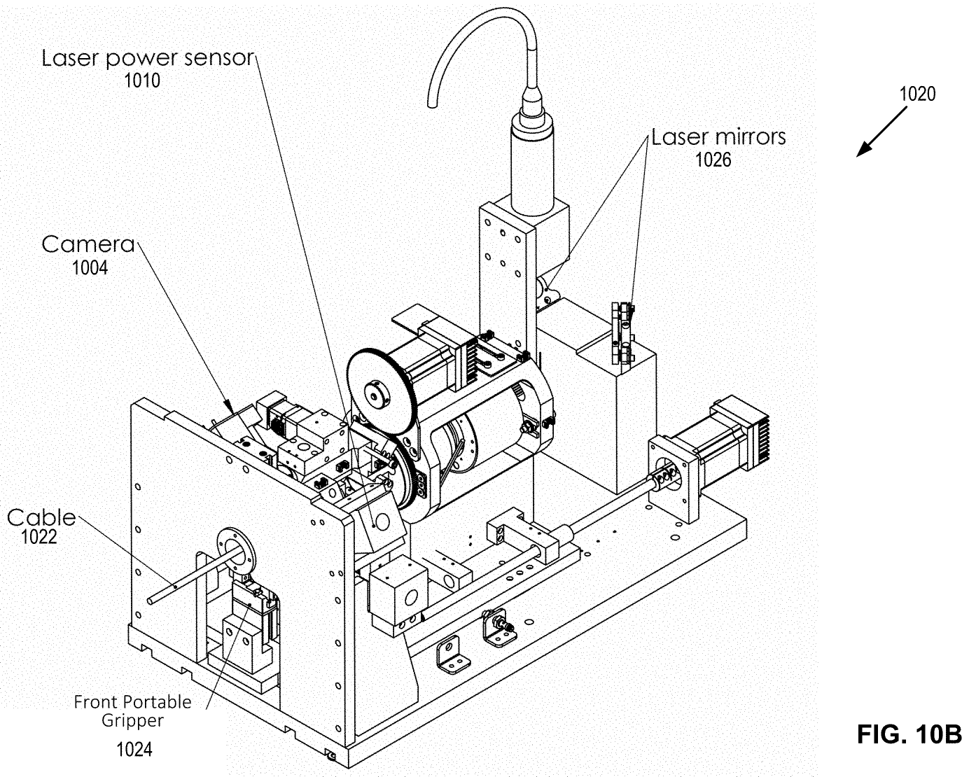

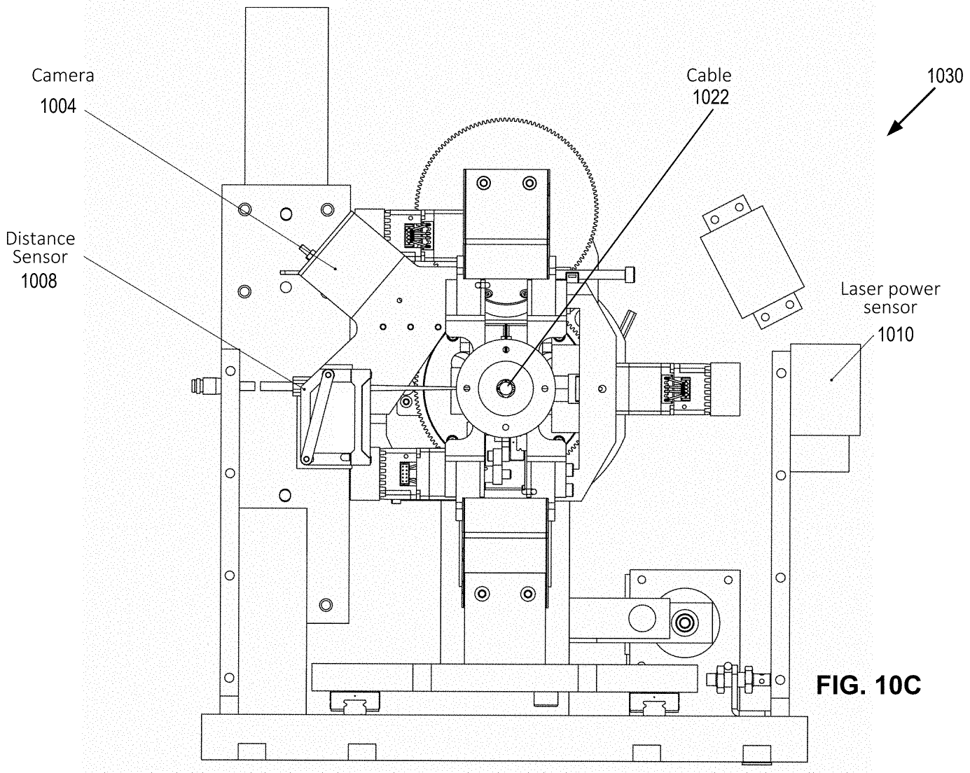

FIG. 10A is a first perspective view 1000 of an example of the system for removing the protective shield from the electrical cable. FIG. 10B is a second perspective 1020 view (opposite the perspective shown in FIG. 10A) of the example of the system for removing the protective shield from the electrical cable. FIG. 10C is a cross-sectional view 1030 of the system for removing the protective shield from the electrical cable illustrated in FIGS. 10A-B.

FIGS. 10A-C illustrates various parts of the system, including front fixed gripper 1002, camera 1004, distance sensor 1008, laser power sensor 1010, laser source 1012, front portable gripper 1024, and laser mirrors 1026. In particular, laser source 1012 may generate a laser, which may be guided by one or more laser mirrors 1026 and the power of which is sensed by laser power sensor 1010.

In addition, the cable 1022 may be held by one or more grippers. In one or some embodiments, the grippers (interchangeably referred to as holders) may grip or hold the cable. In the instance of multiple grippers or holders, such as illustrated in FIGS. 10A-B, the grippers or holders may be positioned in separate parts of the system. Moreover, one gripper may be stationary, such as front fixed gripper 1002, and another gripper may be portable or movable, such as front portable gripper 1024. For example, a portable gripper may be moved based on at least one aspect of the cable, such as where the groove on the cable is placed. In one embodiment, the groove is first ablated onto the protective shield of the cable. After which, the groove is detected (such as by camera 1004) in order to move the position the portable gripper (such as holder 910) relative to the groove (such as groove 906). Alternatively, the portable gripper may be moved prior to the groove is first ablated onto the protective shield of the cable. Specifically, the portable gripper may be moved relative to an anticipated placement of the groove onto the protective shield of the cable.

In one or some embodiments, prior to insertion of the cable into an opening of the machine, the grippers, such as front fixed gripper 1002 and front portable gripper 1024, may be opened. After insertion of the cable into the machine, one of the grippers, such as front fixed gripper 1002, may clasp, grip, or hold onto the cable. Thereafter, a second gripper, such as front portable gripper 1024, may clasp, grip, or hold onto the cable. In this regard, the different grippers may clasp, grip, or hold onto the cable at different times and in a predetermined sequence. Further, the different grippers may clasp, grip, or hold onto different parts of the cable. As one example, the front fixed gripper 1002 may clasp, grip, or hold onto the exterior protective layer (e.g., rubber) 902 whereas the front portable gripper clasp, grip, or hold onto the protective shield 904 of the cable.

Further, distance sensor 1008 may measure or sense the distance to the cable 1022, such as illustrated in FIG. 10C. In this way, one or both of at least a part of the laser system (e.g., the lens(es)) or the cable may be moved to compensate for the measured distance, as discussed above.

It is intended that the foregoing detailed description be understood as an illustration of selected forms that the invention can take and not as a definition of the invention. It is only the following claims, including all equivalents, that are intended to define the scope of the claimed invention. Finally, it should be noted that any aspect of any of the preferred embodiments described herein can be used alone or in combination with one another.

The following example embodiments of the invention are also disclosed:

### Embodiment 1

A method for ablating a protective shield of an electrical cable, the method comprising:
inserting the electrical cable in at least one holder;
sensing, by a sensor, respective distances of the sensor to respective points along a circumference of a surface of the protective shield of the electrical cable while the electrical cable is held in the at least one holder;
determining, based on the respective distances, whether or how much to move at least one of the electrical cable or a part of a laser system in order to position a focus of laser radiation generated by the laser system to be at a predetermined distance relative to the respective points along the circumference of the surface of the protective shield of the electrical cable;
moving the at least one of the electrical cable or a part of a laser system in order to position the focus of laser radiation generated by the laser system to be at the predetermined distance relative to the respective points along the circumference of the surface of the protective shield of the electrical cable; and
operating the laser system to generate the laser radiation, with the position of the focus of the laser radiation at the predetermined distance relative to the respective points along the circumference of the surface of the protective shield of the electrical cable, in order for the laser radiation to ablate at least a part of the protective shield at the respective points along the circumference of the surface of the protective shield of the electrical cable.

### Embodiment 2

The method of embodiment 1:
wherein the laser system comprises a laser and at least one lens; and
wherein moving the at least one of the electrical cable or the part of the laser system a part of a laser system comprises moving the lens.

### Embodiment 3

The method of any of embodiments 1 or 2,
wherein the lens is moved respective compensation distances in order to position the focus of the laser radiation at the predetermined distance relative to the respective points along the circumference of the protective shield of the electrical cable; and
wherein the respective compensation distance comprises a distance to move the lens in order to compensate for a surface deviation at the respective point.

### Embodiment 4

The method of any of embodiments 1-3,
wherein moving the lens the respective compensation distance results in the focus of the laser radiation being outside of the electrical cable by the predetermined distance at the respective point along the circumference of the protective shield of the electrical cable.

### Embodiment 5

The method of any of embodiments 1-4,
wherein a motor pushes the lens in a lateral movement so that the lens is positioned closer to or further away from the electrical cable in order for the focus of the laser to be outside of the electrical cable.

### Embodiment 6

The method of any of embodiments 1-5,
wherein the laser and the lens are positioned on a carousel;
wherein, while the at least one holder holding the electrical cable is stationary, the carousel is rotated so that the laser radiation is applied to the entire circumference of the surface of the protective shield; and
wherein, while the carousel is rotated such that the laser radiation is applied to the entire circumference of the surface of the protective shield, the laser radiation generated by the laser remains constant while the motor moves the lens laterally in order for the focus of the laser radiation to be at the predetermined distance relative to the protective shield of the electrical cable at each respective point along the entire circumference of the surface of the protective shield.

### Embodiment 7

The method of any of embodiments 1-6,
wherein the sensor is positioned on the carousel so that the laser and lens rotate in combination with the sensor.

### Embodiment 8

The method of any of embodiments 1-7,
wherein the laser radiation applied to the entire circumference of the surface of the protective shield ablates some, but not all, of the protective shield thereby generating a groove on the protective shield; and
further comprising:
   gripping, using a gripper, a segment of the protective shield; and
   generating, while the gripper is gripping the segment and while the at least one holder is holding the electrical cable, a twisting movement of the segment of the protective shield and a remainder of the electrical cable relative to one another in order to generate shear stress in the groove on the surface of the at least a part of the protective shield thereby separating the segment of the protective shield from the remainder of the electrical cable.

### Embodiment 9

The method of any of embodiments 1-8,
wherein the laser radiation applied to the entire circumference of the surface of the protective shield entirely ablates the protective shield.

### Embodiment 10

The method of any of embodiments 1-9,
wherein the protective shield comprises a metal shield.

### Embodiment 11

An apparatus for ablating a protective shield of an electrical cable, the apparatus comprising:
at least one holder configured to hold the electrical cable;
at least one sensor configured to sense a distance of the sensor to the electrical cable while the electrical cable is held in the at least one holder;
a laser system including a laser and at least one lens;
at least one motor; and
a processor in communication with the at least one sensor, the laser system, and the at least one motor, the processor configured to:
   receive, from the at least one sensor, respective distances of the sensor to respective points along a circumference of a surface of the protective shield of the electrical cable;
   determine, based on the respective distances, whether or how much to move at least one of the electrical cable or a part of a laser system in order to position a focus of laser radiation generated by the laser system to be at a predetermined distance relative to the respective points along the circumference of the surface of the protective shield of the electrical cable;
   control the at least one motor in order to move the at least one of the electrical cable or a part of a laser system in order to position the focus of laser radiation generated by the laser system to be at the predetermined distance relative to the respective points along the circumference of the surface of the protective shield of the electrical cable; and
   control the laser system in order to generate the laser radiation, with the position of the focus of the laser radiation at the predetermined distance relative to the respective points along the circumference of the surface of the protective shield of the electrical cable, in order for the laser radiation to ablate at least a part of the protective shield at the respective points along the circumference of the surface of the protective shield of the electrical cable.

### Embodiment 12

The method of embodiment 11:
wherein the processor is configured to control the at least one motor in order to move the lens.

### Embodiment 13

The method of any of embodiments 11 or 12,
wherein the processor is configured to control the at least one motor in order to move the lens respective compensation distances in order to position the focus of the laser radiation at the predetermined distance relative to the respective points along the circumference of the protective shield of the electrical cable; and
wherein the respective compensation distance comprises a distance to move the lens in order to compensate for a surface deviation at the respective point.

### Embodiment 14

The method of any of embodiments 11-13,
wherein the processor is configured to control the at least one motor in order to move the lens the respective compensation distance thereby resulting in the focus of the laser radiation being outside of the electrical cable by the predetermined distance at the respective point along the circumference of the protective shield of the electrical cable.

### Embodiment 15

The method of any of embodiments 11-14,
wherein the motor is configured to push the lens in a lateral movement so that the lens is positioned closer to or further away from the electrical cable in order for the focus of the laser to be outside of the electrical cable.

### Embodiment 16

The method of any of embodiments 11-15,
wherein the at least one motor comprises a first motor and a second motor;
wherein the processor is configured to control the first motor in order for the laser system and the at least one holder to move relative to one another in order for the laser radiation to be applied to the entire circumference of the surface of the protective shield; and
wherein the processor is configured to control the second motor in order to move the lens the respective compensation distances such that the focus of the laser radiation is outside of the electrical cable at the predetermined distance relative to the protective shield of the electrical cable at the respective points along the entire circumference of the surface of the protective shield.

### Embodiment 17

The method of any of embodiments 11-16,
further comprising a carousel on which the laser and the lens are positioned;
wherein, while the at least one holder holding the electrical cable is stationary, the processor is configured to control the first motor in order to rotate the carousel so that the laser radiation is applied to the entire circumference of the surface of the protective shield; and
wherein, while the carousel is rotated such that the laser radiation is applied to the entire circumference of the surface of the protective shield, the laser radiation generated by the laser remains constant while the processor controls the second motor in order to move the lens laterally, thereby moving the focus of the laser radiation to be at the predetermined distance relative to the protective shield of the electrical cable at each of the respective points along the entire circumference of the surface of the protective shield.

### Embodiment 18

The method of any of embodiments 11-17,
wherein the sensor is positioned on the carousel so that the laser and lens rotate in combination with the sensor.

### Embodiment 19

The method of any of embodiments 11-18,
wherein the processor controls the laser system such that the laser radiation applied to the entire circumference of the surface of the protective shield ablates some, but not all, of the protective shield thereby generating a groove on the protective shield;
further comprising a gripper configured to grip a segment of the protective shield; and
wherein the processor is configured to control the gripper, the at least one holder, and at least one motor in order to generate, while the gripper is gripping the segment and while the at least one holder is holding the electrical cable, a twisting movement of the segment of the protective shield and a remainder of the electrical cable relative to one another in order to generate shear stress in the groove on the surface of the at least a part of the protective shield thereby separating the segment of the protective shield from the remainder of the electrical cable.

### Embodiment 20

The method of any of embodiments 11-19,
wherein the processor controls the laser system such that the laser radiation is applied to the entire circumference of the surface of the protective shield entirely ablates the protective shield.

### Embodiment 21

The method of any of embodiments 11-20,
wherein the protective shield comprises a metal shield.

### Embodiment 22

A method for ablating a protective shield of an electrical cable, the electrical cable including a protective shield tier comprising the protective shield and an external tier external to the protective shield tier, the method comprising:
removing at least a part of the external tier thereby created an exposed section of the protective shield;
operating a laser system to generate laser radiation in order for the laser radiation to ablate and create a groove on the exposed section of the protective shield, thereby defining a first part of the exposed section of the protective shield on one side of the groove and a second part of the exposed section of the protective shield on another side of the groove; and
while a holder is physically contacting the first part of the exposed section of the protective shield and while a gripper is physically contacting the second part of the exposed section of the protective shield, generating a twisting movement of the first part of the exposed section of the protective shield and the second part of the exposed section of the protective shield relative to one another in order to generate shear stress in the groove thereby separating the second part of the exposed section of the protective shield from the first part of the exposed section of the protective shield.

### Embodiment 23

The method of embodiment 22:
wherein the protective shield tier comprises one or more layers of the protective shield; and
wherein at least a part of the protective shield in the protective shield tier is untouched after the laser radiation is applied such that the twisting movement rips the at least the at least a part of the protective shield that is untouched.

### Embodiment 24

The method of any of embodiments 22 or 23,
wherein the protective shield at least partly overlaps itself along a circumference of the protective shield tier thereby defining an overlapping region of an upper protective shield layer exposed to the laser radiation and a lower protective shield layer; and
wherein at least a part of the lower protective shield layer is untouched after the laser radiation is applied and is ripped by the twisting movement.

### Embodiment 25

The method of any of embodiments 22-24,
wherein the gripper performs the twisting movement while the gripper is physically contacting and gripping the second part of the exposed section of the protective shield; and
wherein the holder remains stationary while the gripper performs the twisting movement and while the holder is physically contacting and holding the first part of the exposed section of the protective shield.

### Embodiment 26

The method of any of embodiments 22-25,
wherein the laser radiation ablates a groove along the entire circumference of the upper protective shield layer.

### Embodiment 27

The method of any of embodiments 22-26,
wherein the twisting movement comprises a greater than 360° twisting movement.

### Embodiment 28

The method of any of embodiments 22-27,
wherein the twisting movement comprises:
   a first twisting movement in a first direction, the first twisting movement greater than 360°; and
   a second twisting movement in a second direction, the second twisting movement greater than 360°, the second direction being in an opposite direction to the first direction.

### Embodiment 29

An apparatus configured to perform the method steps disclosed in any of embodiments 22-28.

1. A method for ablating a protective shield of an electrical cable, the method comprising:
inserting the electrical cable in at least one holder;
sensing, by a sensor, respective distances of the sensor to respective points along a circumference of a surface of the protective shield of the electrical cable while the electrical cable is held in the at least one holder;
determining, based on the respective distances, whether or how much to move at least one of the electrical cable or a part of a laser system in order to position a focus of laser radiation generated by the laser system to be at a predetermined distance relative to the respective points along the circumference of the surface of the protective shield of the electrical cable;
moving the at least one of the electrical cable or a part of a laser system in order to position the focus of laser radiation generated by the laser system to be at the predetermined distance relative to the respective points along the circumference of the surface of the protective shield of the electrical cable; and
operating the laser system to generate the laser radiation, with the position of the focus of the laser radiation at the predetermined distance relative to the respective points along the circumference of the surface of the protective shield of the electrical cable, in order for the laser radiation to ablate at least a part of the protective shield at the respective points along the circumference of the surface of the protective shield of the electrical cable.

2. The method of claim 1, wherein the laser system comprises a laser and at least one lens; and
wherein moving the at least one of the electrical cable or the part of the laser system a part of a laser system comprises moving the lens.

3. The method of claim 2, wherein the lens is moved respective compensation distances in order to position the focus of the laser radiation at the predetermined distance relative to the respective points along the circumference of the protective shield of the electrical cable; and
wherein the respective compensation distance comprises a distance to move the lens in order to compensate for a surface deviation at the respective point.

4. The method of claim 3, wherein moving the lens the respective compensation distance results in the focus of the laser radiation being outside of the electrical cable by the predetermined distance at the respective point along the circumference of the protective shield of the electrical cable.

5. The method of claim 4, wherein a motor pushes the lens in a lateral movement so that the lens is positioned closer to or further away from the electrical cable in order for the focus of the laser to be outside of the electrical cable.

6. The method of claim 5, wherein the laser and the lens are positioned on a carousel;
wherein, while the at least one holder holding the electrical cable is stationary, the carousel is rotated so that the laser radiation is applied to the entire circumference of the surface of the protective shield; and
wherein, while the carousel is rotated such that the laser radiation is applied to the entire circumference of the surface of the protective shield, the laser radiation generated by the laser remains constant while the motor moves the lens laterally in order for the focus of the laser radiation to be at the predetermined distance relative to the protective shield of the electrical cable at each respective point along the entire circumference of the surface of the protective shield.

7. The method of claim 6, wherein the sensor is positioned on the carousel so that the laser and lens rotate in combination with the sensor.

8. The method of claim 6, wherein the laser radiation applied to the entire circumference of the surface of the protective shield ablates some, but not all, of the protective shield thereby generating a groove on the protective shield; and
further comprising:
gripping, using a gripper, a segment of the protective shield; and
generating, while the gripper is gripping the segment and while the at least one holder is holding the electrical cable, a twisting movement of the segment of the protective shield and a remainder of the electrical cable relative to one another in order to generate shear stress in the groove on the surface of the at least a part of the protective shield thereby separating the segment of the protective shield from the remainder of the electrical cable.

9. An apparatus for ablating a protective shield of an electrical cable, the apparatus comprising:
at least one holder configured to hold the electrical cable;
at least one sensor configured to sense a distance of the sensor to the electrical cable while the electrical cable is held in the at least one holder;
a laser system including a laser and at least one lens;
at least one motor; and
a processor in communication with the at least one sensor, the laser system, and the at least one motor, the processor configured to:
receive, from the at least one sensor, respective distances of the sensor to respective points along a circumference of a surface of the protective shield of the electrical cable;
determine, based on the respective distances, whether or how much to move at least one of the electrical cable or a part of a laser system in order to position a focus of laser radiation generated by the laser system to be at a predetermined distance relative to the respective points along the circumference of the surface of the protective shield of the electrical cable;
control the at least one motor in order to move the at least one of the electrical cable or a part of a laser system in order to position the focus of laser radiation generated by the laser system to be at the predetermined distance relative to the respective points along the circumference of the surface of the protective shield of the electrical cable; and
control the laser system in order to generate the laser radiation, with the position of the focus of the laser radiation at the predetermined distance relative to the respective points along the circumference of the surface of the protective shield of the electrical cable, in order for the laser radiation to ablate at least a part of the protective shield at the respective points along the circumference of the surface of the protective shield of the electrical cable.

10. The apparatus of claim 9, wherein the processor is configured to control the at least one motor in order to move the lens respective compensation distances in order to position the focus of the laser radiation at the predetermined distance relative to the respective points along the circumference of the protective shield of the electrical cable; and
wherein the respective compensation distance comprises a distance to move the lens in order to compensate for a surface deviation at the respective point.

11. The apparatus of claim 10, wherein the processor is configured to control the at least one motor in order to move the lens the respective compensation distance thereby resulting in the focus of the laser radiation being outside of the electrical cable by the predetermined distance at the respective point along the circumference of the protective shield of the electrical cable.

12. The apparatus of claim 11, wherein the motor is configured to push the lens in a lateral movement so that the lens is positioned closer to or further away from the electrical cable in order for the focus of the laser to be outside of the electrical cable.

13. The apparatus of claim 12, wherein the at least one motor comprises a first motor and a second motor;
wherein the processor is configured to control the first motor in order for the laser system and the at least one holder to move relative to one another in order for the laser radiation to be applied to the entire circumference of the surface of the protective shield; and
wherein the processor is configured to control the second motor in order to move the lens the respective compensation distances such that the focus of the laser radiation is outside of the electrical cable at the predetermined distance relative to the protective shield of the electrical cable at the respective points along the entire circumference of the surface of the protective shield.

14. The apparatus of claim 13, further comprising a carousel on which the laser and the lens are positioned;
wherein, while the at least one holder holding the electrical cable is stationary, the processor is configured to control the first motor in order to rotate the carousel so that the laser radiation is applied to the entire circumference of the surface of the protective shield; and
wherein, while the carousel is rotated such that the laser radiation is applied to the entire circumference of the surface of the protective shield, the laser radiation generated by the laser remains constant while the processor controls the second motor in order to move the lens laterally, thereby moving the focus of the laser radiation to be at the predetermined distance relative to the protective shield of the electrical cable at each of the respective points along the entire circumference of the surface of the protective shield.

15. The apparatus of claim 14, wherein the sensor is positioned on the carousel so that the laser and lens rotate in combination with the sensor.

16. The apparatus of claim 14, wherein the processor controls the laser system such that the laser radiation applied to the entire circumference of the surface of the protective shield ablates some, but not all, of the protective shield thereby generating a groove on the protective shield;
further comprising a gripper configured to grip a segment of the protective shield; and
wherein the processor is configured to control the gripper, the at least one holder, and at least one motor in order to generate, while the gripper is gripping the segment and while the at least one holder is holding the electrical cable, a twisting movement of the segment of the protective shield and a remainder of the electrical cable relative to one another in order to generate shear stress in the groove on the surface of the at least a part of the protective shield thereby separating the segment of the protective shield from the remainder of the electrical cable.

17. The apparatus of claim 14, wherein the processor controls the laser system such that the laser radiation is applied to the entire circumference of the surface of the protective shield entirely ablates the protective shield; and
wherein the protective shield comprises a metal shield.

18. A method for ablating a protective shield of an electrical cable, the electrical cable including a protective shield tier comprising the protective shield and an external tier external to the protective shield tier, the method comprising:
removing at least a part of the external tier thereby created an exposed section of the protective shield;
operating a laser system to generate laser radiation in order for the laser radiation to ablate and create a groove on the exposed section of the protective shield, thereby defining a first part of the exposed section of the protective shield on one side of the groove and a second part of the exposed section of the protective shield on another side of the groove; and
while a holder is physically contacting the first part of the exposed section of the protective shield and while a gripper is physically contacting the second part of the exposed section of the protective shield, generating a twisting movement of the first part of the exposed section of the protective shield and the second part of the exposed section of the protective shield relative to one another in order to generate shear stress in the groove thereby separating the second part of the exposed section of the protective shield from the first part of the exposed section of the protective shield.

19. The method of claim 18, wherein the protective shield tier comprises one or more layers of the protective shield; and
wherein at least a part of the protective shield in the protective shield tier is untouched after the laser radiation is applied such that the twisting movement rips the at least the at least a part of the protective shield that is untouched.

20. The method of claim 19, wherein the protective shield at least partly overlaps itself along a circumference of the protective shield tier thereby defining an overlapping region of an upper protective shield layer exposed to the laser radiation and a lower protective shield layer; and
wherein at least a part of the lower protective shield layer is untouched after the laser radiation is applied and is ripped by the twisting movement.

21. The method of claim 20, wherein the gripper performs the twisting movement while the gripper is physically contacting and gripping the second part of the exposed section of the protective shield; and
wherein the holder remains stationary while the gripper performs the twisting movement and while the holder is physically contacting and holding the first part of the exposed section of the protective shield.

22. The method of claim 21, wherein the laser radiation ablates a groove along the entire circumference of the upper protective shield layer;
wherein the twisting movement comprises a greater than 360° twisting movement; and
wherein the twisting movement comprises:
a first twisting movement in a first direction, the first twisting movement greater than 360°; and
a second twisting movement in a second direction, the second twisting movement greater than 360°, the second direction being in an opposite direction to the first direction.
